(19) United States
(12) Patent Application Publication
(10) Pub. No.: US 2012/0174725 A1
(43) Pub. Date: Jul. 12, 2012

(54) COMB-SHAPED UNIT USED IN A MUSIC BOX WITH MULTIPLE MUSICAL SCALES

(75) Inventor: LUNG-HSI HUANG, Dali City (TW)

(73) Assignee: Kyooh Precision Industry Co., Ltd.

(21) Appl. No.: 13/004,079

(22) Filed: Jan. 11, 2011

(51) Int. Cl. G10F 1/06

(52) U.S. Cl. 84/94.1

(57) ABSTRACT

A comb-shaped unit used in a music box includes a plurality of metallic strips and an integrally formed striker unit. Melodious music may be generated by the relative motion and hence the friction between the small protrusions and the comb-shaped unit as the cylindrical drum rotates. The strips are spaced apart. Each of some of the strips has a striker provided on its end portion. These strikers are in different sizes. The steel strips of the comb-shaped unit have a greater thickness and hence there is no need for the lead members of the strikers and the additional processes in the prior art. Therefore, the low-frequency effect may be reached and the relevant environmental protection regulations of European Union and the US may be met.

### BACKGROUND OF THE INVENTION

1. Field of the Invention

The invention generally relates to a music producing unit used in a music box with multiple musical scales. More particularly, the invention relates to an improved comb-shaped unit used in a music box with multiple musical scales.

2. Description of the Prior Art

Music box has been around for a long time. According to the literature, music box was invented by a Swiss man, Antoine Faver, in 1796. In such music box, as a cylindrical drum 20 rotates, crystal-clear melodious music may be generated through the friction between the strips 10 in different lengths and the small protrusions 21 fitted on the outer surface of the drum.

Please refer to FIG. 1, which is a perspective view of the music box of the prior art. The music producing mechanism of the music box comprises a spring (not shown in the drawing), a comb-shaped unit 10 and a cylindrical drum 20. As shown in FIG. 2, the comb-shaped unit 10 is made of a special type of steel and has the appearance of a comb. The comb-shaped unit 10 consists of several strips 11. As the strips 11 rubs against the small protrusions 21 located on the outer surface of the drum 20, music may be generated. The frequency is determined by the widths of the strips 11 and the lengths and weights of the strikers 12 provided on the front end of each strip. An object produces a lower natural frequency if it is shorter and lighter. An object has a higher innate frequency if it is longer and heavier. Whence, we may wind the music box so that its spring and gears may prompt the drum 20 to rotate in the outward direction to generate music by the friction between the strips 10 and the small protrusions.

As of now, the manufacturing procedure of the comb-shaped unit 10, with the thickness of 1.5 mm, is quite complicated. First, a preliminary form of the comb-shaped unit 10 is obtained by stamping. Then, a shearing machine is used to make the grooves. Next, the rounded front ends are obtained by grinding. Also, a cutting machine is used to obtain the shape of a comb. Then, a lead casting process is used to make the strikers 12 (the areas marked by the cross lines in FIG. 2), which are to be fitted on the front portions of some strips. Lead is toxic to our kidney and nervous system and the use of lead does not meet the environmental protection regulations of the US and Europe. Also, lead poses occupational hazard to the people engaging in the manufacturing of the comb-shaped unit 10. The last step is attaching a plastic damping piece to the front end of each strip. Such step is quite time-consuming and these plastic pieces detach from the strips quite easily, affecting the final product and increasing the manufacturing cost. Therefore, there are many disadvantages of the comb-shaped unit in the manufacturing and these disadvantages have been plaguing the relevant manufacturers. Therefore, there is a need for a comb-shaped unit that meets the environmental protection regulations of the US and Europe, whose low-frequency section has the low-frequency effect and which has a lower manufacturing cost.

### SUMMARY OF THE INVENTION

An object of the present invention is to provide an improved comb-shaped unit in which the strips have greater thickness and the strips on the low-frequency section have greater width. Also, the weight of the lead members in the prior art is properly distributed on the strikers to obtain the optimal range of vibration frequency.

Another object of the present invention is to provide a comb-shaped unit, in which its steel strips have a greater thickness and hence there is no need for the lead members attached to the strikers in the low-frequency section of the striker unit and the additional processes in the prior art. Therefore, the comb-shaped unit of the present invention meets the relevant environmental protection regulations of European Union and the US.

A third object of the present invention is to provide a comb-shaped unit, in which no plastic damping piece is needed on the front end of each striker.

A fourth object of the present invention is to provide a comb-shaped unit, in which production is simplified, less time is needed in the production and production cost is lowered.

To reach these objects, the improved comb-shaped unit of the present invention is disclosed. The comb-shaped unit of the present invention comprises a plurality of metallic strips and an integrally formed striker unit. Melodious music may be generated by the relative motion and hence the friction between the small protrusions and the comb-shaped unit as the cylindrical drum rotates. Some of the strips have the same width and other strips have a different width. The striker unit is provided on some of the strips and has four sides and a height equal or less than that of the comb-shaped unit. In addition, the COG (center of gravity) of the striker unit is located within its four sides. The widths of the strips provided with the striker unit increase from the right side to the left side so to obtain the optimal range of vibration frequency. The COG of the striker unit may be adjusted by the distance between its two sides. The length of each striker is determined and adjusted by the distance between the two sides. Therefore, the strikers are formed on the end portions of some of the strips and are close to the small protrusions of the cylindrical drum. Whence, we may wind the music box so that its spring and gears may prompt the drum to rotate in the outward direction to generate music by the friction between the strips and the small protrusions.

### BRIEF DESCRIPTION OF THE DRAWINGS

The drawings disclose an illustrative embodiment of the present invention which serves to exemplify the various advantages and objects hereof, and are as follows:

FIG. 1 is a perspective view of the music box of the prior art, showing that melodious music may be generated by the relative motion and hence the friction between the small protrusions and the comb-shaped unit as a metallic cylindrical drum rotates.

FIG. 2 is a perspective view of a comb-shaped unit of the prior art.

FIG. 3 is a perspective view of a comb-shaped unit of the present invention.

FIG. 4 is a left side view of a comb-shaped unit of the present invention, showing T (the length of any striker, gradually changing from the left side to the right side).

FIG. 5 is a top view of a comb-shaped unit of the present invention, showing that T gradually decreases from the left side to the right side.

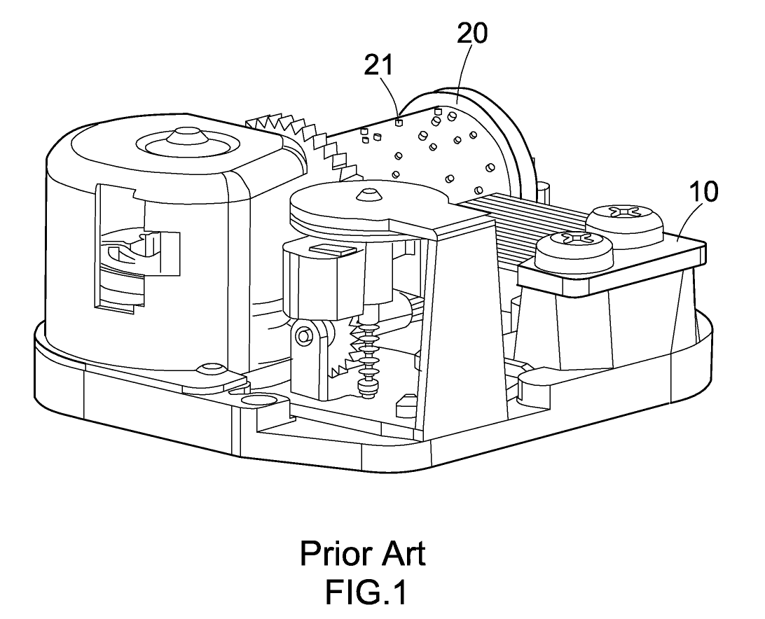

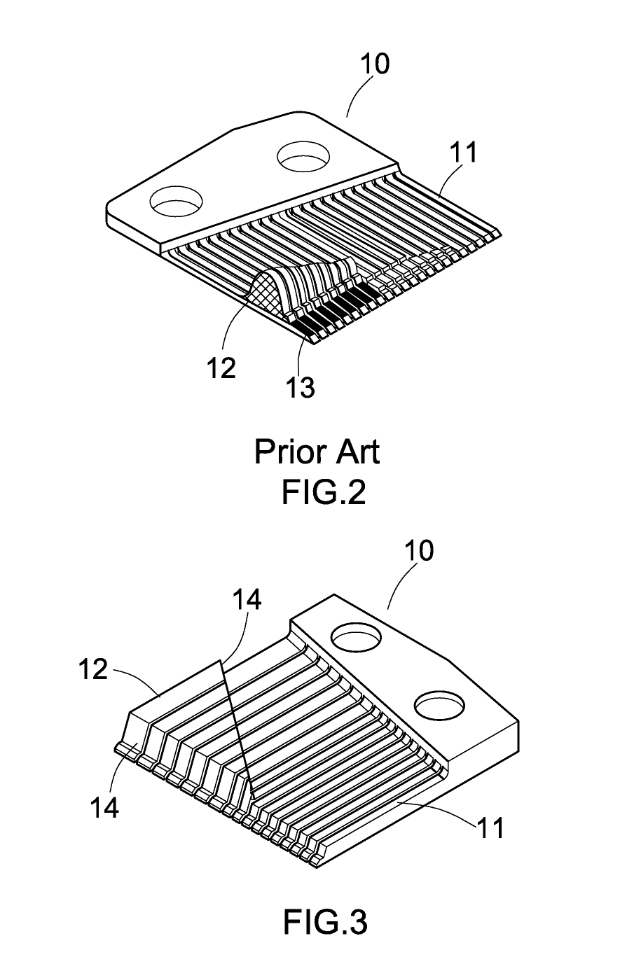

### DETAILED DESCRIPTION OF THE PREFERRED EMBODIMENT

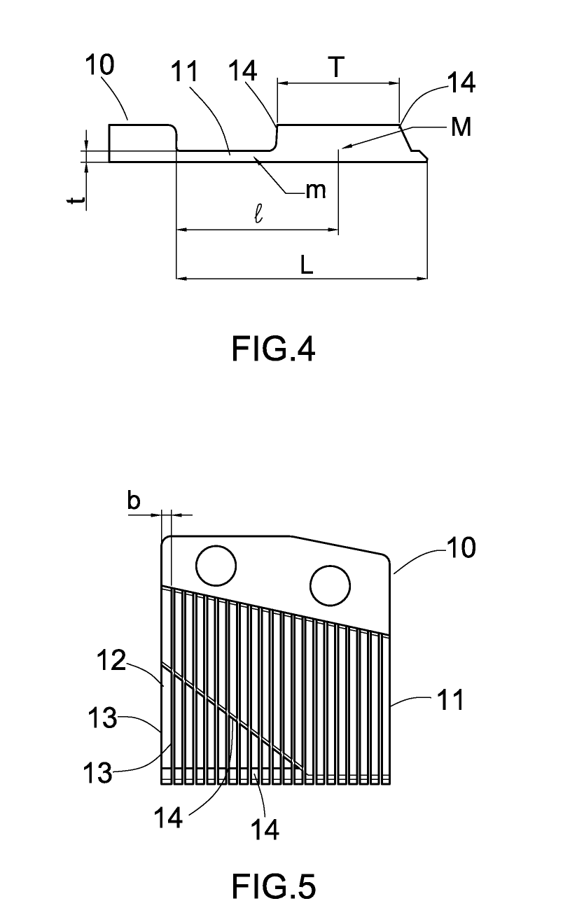

Please refer to FIGS. 3 and 4. Because the end of a comb-shaped unit 10 rubs against a plurality of small protrusions 21 provided on the cylindrical drum 20, melodious music may be generated by the relative motion and hence the friction between the small protrusions 21 and the comb-shaped unit 10 as the cylindrical drum 20 rotates. The comb-shaped unit 10 has a plurality of metallic strips 11, which are spaced apart. Some of the strips 11 have the same width, and other strips 11 have a different width. An integrally formed striker unit 12 is provided on some of the strips 11. The striker unit 12 has four sides and a height equal or less than that of the comb-shaped unit 10. In addition, the COG (center of gravity) of the striker unit 12 is located within its four sides.

Please refer to FIGS. 4 and 5. The following equation may be used to obtain the frequencies that we want by manipulating the location of the COG of the striker unit 12.

$$f = \frac{1}{2 π} \sqrt{\frac{K}{M {l}^{3} / {L}^{3} + 33 / 140 m}} \\ * but K = 3 E {I}^{3} / L ( Kg \text{/} mm )$$

$$I = {bt}^{3} / 12 ( {mm}^{4} )$$

In the equation,
g=9.8×10³ mm/sec²,
E (elasticity)=2.1×10³ kg/mm²,
ρ (density)=7.85×10⁻⁶ kg/mm³,
t=the thickness of the strip,
b=the width of the strip,
L=the length of the strip,
l=the distance from the COG of the striker unit,
M=the weight of the striker,
m=the weight of the strip.

This equation may be used to obtain the optimal range of vibration frequency. The center of gravity (COG) of the striker unit 12 may be adjusted by manipulating the distance between the two sides 14 (either side is adjacent to the longitudinal side 13) so that the COG is located within the fours sides of the striker unit 12. Therefore, with the striker unit 12 formed on the front end portion of the strips 11, as we rotate the cylindrical drum 20, music may be generated by the relative motion and hence the friction between the small protrusions 21 and the striker unit 12. In the low-frequency section 11 of the striker unit 12, the width of the strips increases from the right side to the left side.

Also, the main purpose of the use of the striker unit 12 is to obtain the optimal frequencies of the low-frequency section and hence no striker unit is provided on the high-frequency section 11. Also, the strips 11 are equally or unequally spaced apart and the length of each striker is determined and adjusted by the distance between the two sides. In the low-frequency section 11, from the right side to the left side, the strikers gradually increase in length and width.

Therefore, in such comb-shaped unit 10, there is no need for the lead casting process in the manufacturing procedure, and the environmental protection regulations, such as the RoHs of European Union and REACH of the US, may be met. Because the comb-shaped unit 10 is integrally formed, its strength is enhanced. In addition, there is no need to attach a plastic damping piece 13 to the front end of each striker 12.

The manufacturing procedure of the improved comb-shaped unit 10 of the present invention is simplified. First, a shearing machine is used to make the preliminary form to the desired thickness. Then, a cutting machine is used to cut up the strips according to the desired widths. No labor would be needed to attach a plastic damping piece 13 to the front end of each strip. Therefore, the improved comb-shaped unit 10 of the present invention is suitable for mass-production and this enhances its commercial usefulness. In addition, the low-frequency section of the comb-shaped unit 10 has the low-frequency sound quality provided by the lead casting process. This increases the economic value of the improved comb-shaped unit 10 of the present invention.

In comparison to the prior art, the comb-shaped unit 10 of the present invention has the following advantages:
1. Each of the strips of the comb-shaped unit 10 has an increased thickness and the lowest frequency strip has an increased width. In addition, the weight needed by the strikers of the low-frequency section is properly distributed on each individual strips of the low-frequency section to obtain the optimal range of vibration frequency.
2. The steel strips of the comb-shaped unit 10 have a greater thickness and hence there is no need for the lead members attached to the strikers and the additional processes in the prior art. Therefore, the comb-shaped unit 10 of the present invention meets the RoHs of European Union and REACH of the US.
3. No damping piece is needed on the front end of each striker.
4. Therefore, production is simplified and cost is lowered.
5. The comb-shaped unit 10 is integrally formed and hence its strength is enhanced.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A comb-shaped unit used in a music box with multiple musical scales, comprising:
a plurality of metallic strips, wherein some of the strips have the same width and other strips have a different width; and
an integrally formed striker unit, which is provided on some of the strips, wherein the striker unit has four sides and a height equal or less than that of the comb-shaped unit, and wherein the COG (center of gravity) of the striker unit is located within its four sides,
characterized in that melodious music may be generated by the relative motion and hence the friction between the small protrusions and the comb-shaped unit as the cylindrical drum rotates.

2. The comb-shaped unit as in claim 1, wherein the widths of the strips provided with the striker unit increase from the right side to the left side so to obtain the optimal range of vibration frequency.

3. The comb-shaped unit as in claim 1, wherein the striker unit has four sides and the center of gravity (COG) of the striker unit may be adjusted by manipulating the distance between two of the four sides.

4. The comb-shaped unit as in claim 1, wherein the strips are equally or unequally spaced apart and the length of each striker is determined and adjusted by the distance between the two sides.

5. The comb-shaped unit as in claim 1, wherein the striker unit is formed at the end portion of the strips and is close to the small protrusions provided on the cylindrical drum.
